(19) United States
(12) Patent Application Publication
(10) Pub. No.: US 2013/0069774 A1
(43) Pub. Date: Mar. 21, 2013

(54) Talking Speedometer

(71) Applicants: Elizabeth Ajala, Mount Vernon, NY (US); Emmanuel Ajala, Mt. Vernon, NY (US)

(72) Inventors: Elizabeth Ajala, Mount Vernon, NY (US); Emmanuel Ajala, Mt. Vernon, NY (US)

(21) Appl. No.: 13/235,505

(22) Filed: Sep. 19, 2011

(51) Int. Cl. B60Q 11/00

(52) U.S. Cl. 340/441

(57) ABSTRACT

A simple talking speedometer for motor vehicles. The speedometer includes at least two layers, one for display speed marks, the other for a panel of light sensors positioned similarly as the speed marks. A speed pointer capable of blocking light or emitting light rotates when there is speed, and the rotating of the speed pointer to a speed mark triggers a corresponding light sensor to send a signal for a corresponding voice message be picked by a computer microchip and spoken by a speaker.

### DESCRIPTION OF RELATED ART

The present application relates to an automobile speedometer, and more particularly to a talking speedometer that pronounces the driving speed of a motor vehicle at certain speed points.

Note that the points discussed below may reflect the hindsight gained from the disclosed inventions, and are not necessarily admitted to be prior art.

Automobile safety has been a major concern for the automobile industry. Many safety features have designed, for example, passenger restraints, improved braking systems, body designs are offered to better protect automobiles drivers and passengers. Extensive computerized video camera systems have been developed for alerting automobile drivers of road safety issues. For example, U.S. Pat. No. 6,906,639 B2 describes a motor vehicle warning system that includes a television camera system to scan the roadway and a computerized image analysis system for generating warning signals.

However, these safety systems are extensive and will incur significant increase in cost in manufacturing. The added features may not suitable for economical buyers.

### SUMMARY

The present application discloses new approaches to provide safety features to a motor vehicle with simple improvement on the current speedometers, by making them to speak out the speed to remind a driver about the speed of his driving.

In one embodiment, a motor vehicle speedometer comprises at least two layers, one layer for speedometer mechanical speed hand pointer for speed display, one layer for a panel of sensors that senses the position of the speed pointer.

In one aspect of an embodiment, the sensors are optical sensors; in another aspect of an embodiment, the sensors are photosensors.

In one aspect of an embodiment, the speed pointer has an extended bar attached to block sensor light; in another aspect of an embodiment, the speed pointer has an attached LED light panel to provide light source for a panel of photosensors to detect the position of the speed pointer.

A computer processor with digitally pre-recorded messages and a speaker are connected with the sensor system. At a major speed tick, a sensor is activated by the speed pointer's light blocking or light emitting, a speed message is triggered to be played by the speaker, and the driver is therefore informed of the speed with a voice.

The disclosed innovation, in various embodiments, provides a simple and economical solution to automobile safety. The voice of the speedometer may wake up a driver when dozing, and constantly remind a driver of his speed, allowing a driver to be substantially more conscious about his speeding.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 shows a perspective view of an example automobile speedometer in accordance with this application.

FIG. 2A shows a perspective view of an example speedometer speed pointer at an upright position in accordance with this application.

FIG. 2B shows a perspective view of an example speedometer speed pointer at a face down position in accordance with this application.

FIG. 3 shows a perspective view of an example upper display face layer of a speedometer in accordance with this application.

FIG. 4 shows a perspective view of an example lower sensor panel of a speedometer in accordance with this application.

FIG. 5 shows a flow chart of triggering a voice report of speed in a speedometer in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to all speedometers that have a speed pointer, and to all suitable materials, preferably plastic or metal. The talking speedometer design may be used for other purposes other than automobiles, such as on boat, or on a plane, in sport machines, etc. A person in the art knows to adjust the scale and proper talking messages for those other purposes.

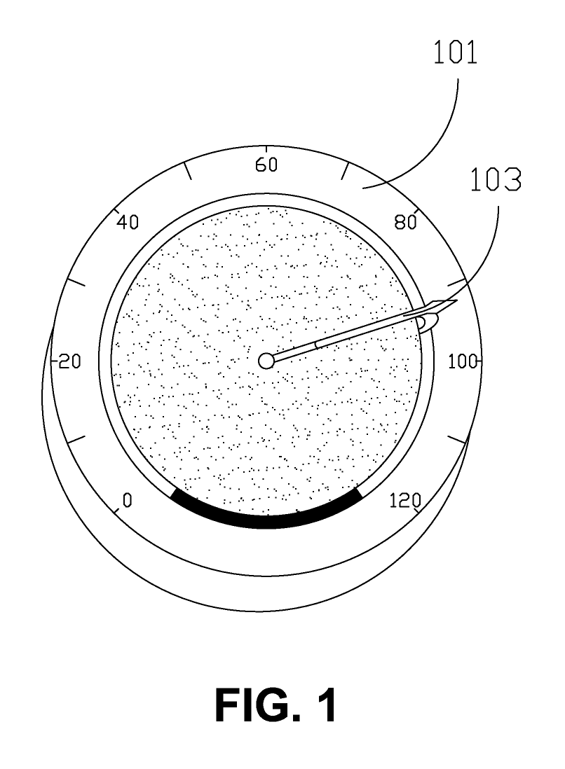

In reference to FIG. 1, a talking speedometer includes a speed pointer 103, a speed display face 101 and a second layer 105 for a panel of sensors that are connected to a speaker and a computer logic integrated chip for commanding and triggering message playing. Pointer 103 is anchored at the center pointer of display face 101, and rotates according to different motor vehicle speed sensed by the speedometer. The rotating mechanism is in accordance with any current available commercial speedometers.

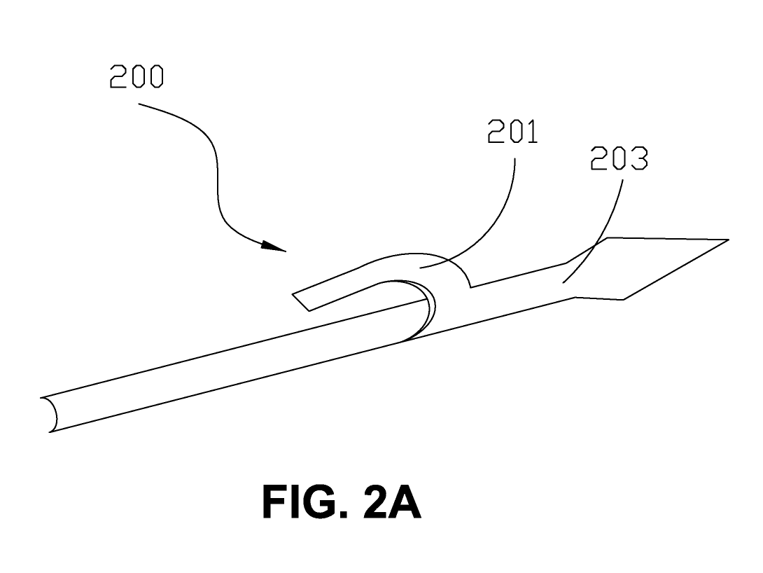

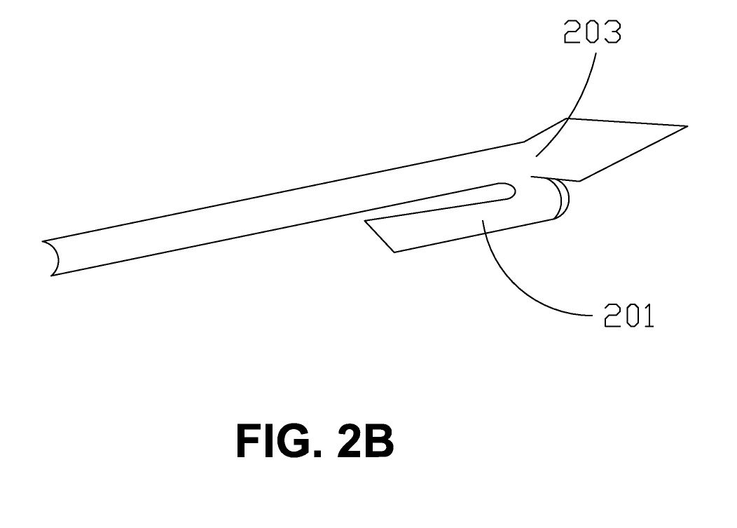

In reference to FIGS. 2A and 2B, a speed pointer is configured to have an elongated pointer 203 and a short attached bar 201. Bar 201 is configured to block light for a light sensor so that an affected light sensor would trigger a voice response. The mounting of bar 201 to pointer 203 in a way that allows for sufficient space for the display face layer to be sandwiched, the pointer can rotate around the anchor center point. Alternatively, a LET light may be attached to bar 201 for additional light, so the additional light is sensed by a light sensor when they are close enough and triggers a voice response from pre-record message.

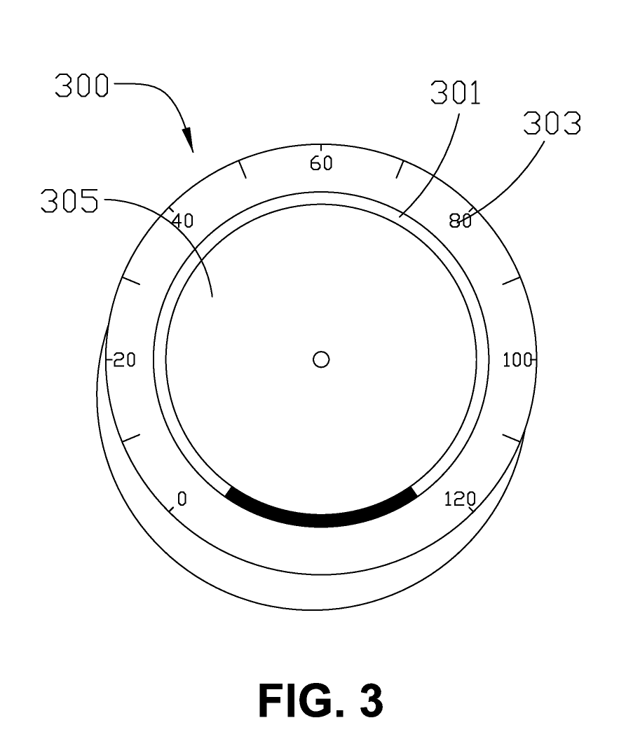

In reference to FIG. 3, the speed display face is specifically designed to accommodate the speed pointer having an attached bar structure. The display face includes at least an inner circular plate 305 and an outer circular ring 303, both being concentric to each other. Between circular plate 305 and circular ring 303 forms a circular gap 301 allowing speed pointer to insert the bar structure and sandwich plate 305 between the bar and the elongated pointer body. Along the peripheral ring 303, speed ticks are marked to indicate a possible sensed speed. When motor vehicle front wheels start to rotate, a rotation sensor mounted in the transmission delivers a series of electronic pulses whose frequency corresponds to the average rotational speed of the driveshaft, and therefore the vehicle's speed, and the magnets or teeth pass beneath the sensor each time produces a pulse in the sensor affecting the strength of the magnetic field which would drive speed pointer 200 to rotate along plate 301 and ring 303, and pointing to a speed tick on ring 303.

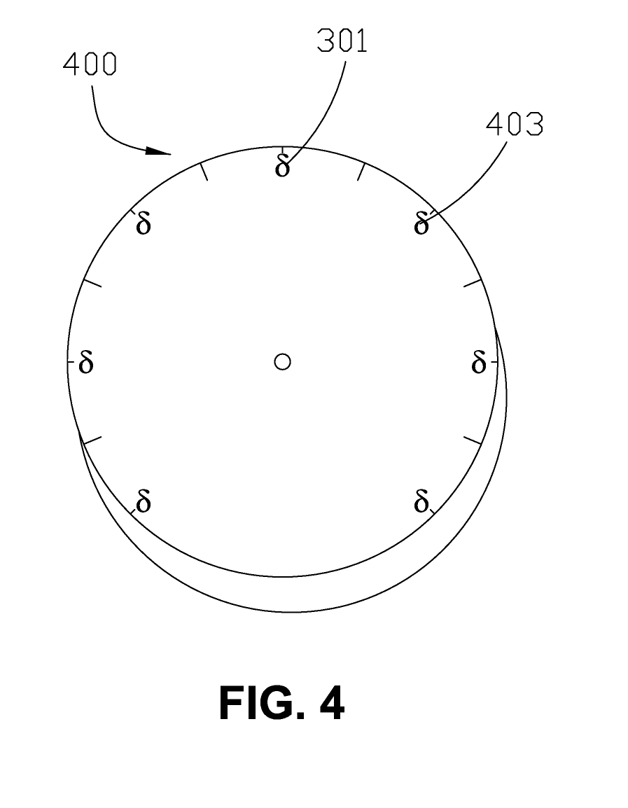

In reference to FIG. 4, a lower layer 400 in substantial the same shape to that of the face display layer includes a panel of light sensors 401, 403, each positioned in corresponding to each individual speed tick of the face display layer. As speed pointer 200 rotates to one of the speed tick, bar 201 may either block light from the corresponding light sensor, or alternatively, emit additional light to the corresponding light sensor. For example, when light pointer 200 points to the direction of sensor 401, light to sensor 401 may be blocked by bar 201 or alternatively bar 201 emits additional light to light sensor 401. Sensor 401 may therefore be an optical sensor or a photosensor, depending on the mechanisms used. The sensed change in lighting strength triggers sensor 401 to send a signal to the controlling computer processor logic chip, which in turn sends a corresponding signal to play a pre-recorded message corresponding to sensor 401 to a speaker. The recorded message may be an announcement of the corresponding speed and/or a reminder for over-speeding.

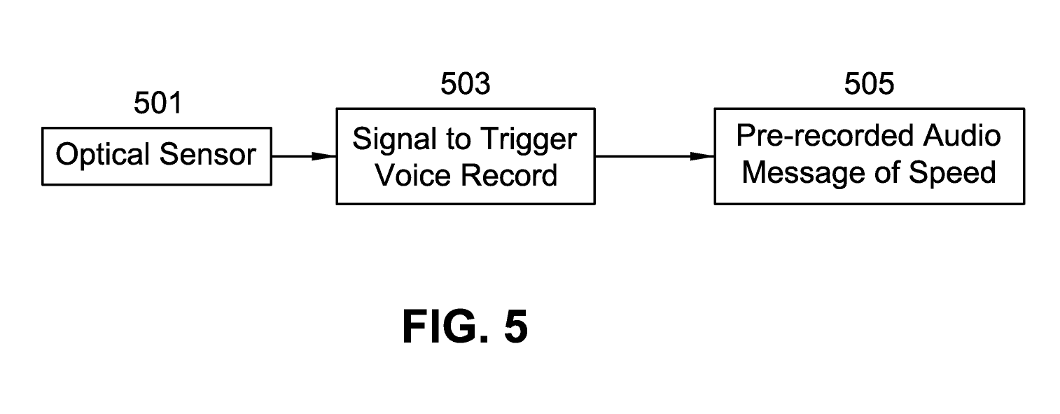

In reference to FIG. 5, it shows a flowchart of the controlling process for a computer logic integrated chip design. At step 501, an optical sensor senses a change in lighting due to the rotation of the speed pointer which may block light or emit more light to the sensor. The signals from the affected sensor then trigger a response signal at step 503 in the computer chip which then locates a voice message that corresponds to the sensor, and therefore the corresponding speed tick on the display face. At step 505, the message is sent to a speaker for playing. Therefore the speedometer talks to the driver about passing a speed tick. An example of light sensing and control can be found in US patent application publication US 2011/0148315 A1, the entirety of which is therefore incorporated by reference.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publication, all of which are hereby incorporated by reference herein for all purposes: U.S. Pat. No. 6,906,639 B2.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A talking automobile speedometer, comprising:
a speed pointer mounted with a bar;
a speed display face marked with a plurality of speed marks having a central point, wherein said speed pointer is rotately mounted at the central point, said speed pointer rotates to point to one of said speed marks upon sensing of a speed;
a second panel matching in shape to said speed display face, disposed with a plurality of light sensors, each being at a corresponding position to one of said speed marks, said second panel and said speed display face being assembled that one said speed mark pairs in position with one said light sensor; and
a computer microchip stored with a plurality of voice messages, each corresponding to one of said light sensors,
wherein rotating said speed pointer to a speed mark triggers a corresponding light sensor to send a signal to said computer microchip and said microchip to send a corresponding speed message to be played by a speaker.

2. The talking automobile speedometer of claim 1, wherein said bar of said speed pointer blocks light in triggering one corresponding said light sensors.

3. The talking automobile speedometer of claim 1, wherein said bar of said speed pointer emits light in triggering one corresponding said light sensors.

4. The talking automobile speedometer of claim 1, wherein at least one said light sensor is a photosensor.

5. The talking automobile speedometer of claim 1, wherein at least one said light sensor is an opticsensor.
